(19) United States
(12) Patent Application Publication
(10) Pub. No.: US 2003/0204461 A1
(43) Pub. Date: Oct. 30, 2003

(54) System for mapping financial disclosure data into compliance information

(76) Inventors: Alex Magary, Brookline, MA (US); Manish Kumar Vaish, Rohini (IN)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/135,834

(22) Filed: Apr. 30, 2002

(51) Int. Cl. G06F 17/60

(52) U.S. Cl. 705/36

(57) ABSTRACT

A system for creating tagged financial documents which are computer readable The system extracts compliance information and inserts tags related to particular financial data. The tags may be computer readable so the tagged information may be easily found and manipulated.

### TECHNICAL FIELD

This invention relates to mapping financial disclosure information for securities stored in a computer-readable form to extract only certain information such as a mutual fund prospectus.

### BACKGROUND INFORMATION

Government agencies and securities exchanges require that certain information be made available to an investor before a security is sold to the investor and that certain information be delivered to an investor with the confirmation of any transaction. The delivery of this information has historically taken place either in person, or via document delivery services, such as the U.S. Mail, Federal Express, or United Parcel Service. Recently, government agencies and securities exchanges have begun allowing securities issuers and intermediaries to comply with information delivery requirements by approving the delivery of the information in an electronic format, for example, by transmitting the information from one computer to another over a computer network.

Securities information is available in various electronic databases including the United States Securities and Exchange Commission's (“SEC”) EDGAR database. EDGAR, the Electronic Data Gathering, Analysis, and Retrieval system, performs automated collection, validation, indexing, acceptance, and forwarding of submissions by companies and others that are required by law to file information with the SEC. The primary purpose of EDGAR is to increase the efficiency and fairness of the securities market for the benefit of investors, corporations, and the economy by accelerating the receipt, acceptance, dissemination, and analysis of time-sensitive corporate information filed with the agency. EDGAR information is available on the Internet at www.sec.gov. The United States Internal Revenue Service (“IRS”) may also offer regulations regarding the electronic filing of information.

Although securities information is available from databases like EDGAR, the information is not readily available in a useful electronic format that enables compliance with government and securities exchange regulations, especially with regard to mutual funds and other non-corporate securities. EDGAR, as a result of its design, makes information regarding non-corporate securities difficult to find. In EDGAR, mutual fund information, for example, is listed as a submission of the corporate issuer, not the fund name that is marketed to the consumer, and one submission may include information for more than one mutual fund. EDGAR submissions also may include updates and amendments to earlier submitted information. It is quite possible for a single mutual fund to have more than fifty amendments to its compliance information. An investor attempting to locate the complete set of compliance information for a mutual fund directly from EDGAR would need to retrieve all applicable amendments. This is time-consuming, and it is difficult for the investor, when attempting to gather compliance information from EDGAR, to know if all the amendments have actually been located, if the retrieved information about the fund is complete, or if the retrieved information is up-to-date.

### SUMMARY OF THE INVENTION

Offered is a method of preparing a computer-readable securities file, the method comprising: defining a set of data attributes; retrieving a document from a database; preparing a computer-readable securities file from the document, wherein a data point having an attribute within the defined set, and found within the computer-readable securities file, is marked as having the attribute in the computer-readable securities file. In the method the computer-readable securities file may be marked according to a standard generalized mark-up language standard. In the method the computer-readable securities file may be marked according to an eXtensible Markup Language standard. In the method the set of attributes may comprise one or more of the following: a CUSIP number; a stock ticker symbols; monetary data; average returns; fund manager; net assets; investment objective. The method may further comprise generating a user-readable-securities file from the computer-readable securities file. The method may also further comprise sending the user-readable securities file to a user. In another embodiment the method may further comprise generating a graphical display from the computer-readable securities file. In a further embodiment the method may further comprise sending the graphical display to a user. In a further embodiment of the method, the sending comprises sending a user a hyperlink which points to the graphical display. In another embodiment of the method the database is a database operated under the rules of the United States Securities and Exchange Commission, or the United States Internal Revenue Service. The database may be EDGAR. In still a further embodiment the method may further comprise sending the set of data attributes to a user. The method may further comprise generating an attribute file comprising one or more data points having an attribute within the defined set. The attribute file may be sent to a user.

Also offered is a method of preparing a computer-readable securities file, the method comprising: defining a set of data attributes; retrieving a document from a database; marking information relevant to a security in the retrieved document; preparing a computer-readable document comprising the marked relevant information; preparing a computer-readable securities file from the computer-readable document, wherein a data point having an attribute within the defined set, and found within the computer-readable securities file, is marked as having the attribute in the computer-readable securities file.

Also offered is a method of preparing a computer-readable securities file, the method comprising: defining a set of data attributes; retrieving a document from the database; marking information relevant to a security in the retrieved document; preparing a first computer-readable document comprising the marked relevant information; preparing a second computer-readable document from the first computer-readable document, wherein a data point having an attribute within the defined set, and found within the second computer-readable document, is marked as having the attribute in the second computer-readable document; and generating the computer-readable securities file from the second computer-readable document. In this method the second computer-readable document may be marked according to a standard generalized mark-up language standard. Also, the second computer-readable document may be marked according to an extensible Markup Language standard. The security may be a mutual fund.

Further offered a method for tagging a securities document, the method comprising: retrieving compliance information from a database; identifying a particular data point located in the compliance information; and inserting a tag identifying the particular data point into the compliance information. In this method the database may be a database operated under the rules of the United States Securities and Exchange Commission, or the United States Internal Revenue Service. In one embodiment of the method the database is EDGAR. In another embodiment the tag is computer-readable. In a further embodiment the tag is inserted according to a standard generalized mark-up language standard. In a further embodiment the tag is inserted according to an eXtensible Markup Language standard.

Also offered is a system for preparing a computer-readable securities file, the system comprising a document processor programmed to: define a set of data attributes; retrieve a document from a database; prepare a computer-readable securities file from the document, wherein a data point having an attribute within the defined set, and found within the computer-readable securities file, is marked as having the attribute in the computer-readable securities file. In the system the computer-readable securities file may be marked according to a standard generalized mark-up language standard. The computer-readable securities file may be marked according to an extensible Markup Language standard. In one embodiment the set of attributes comprises one or more of the following: a CUSIP number; a stock ticker symbols; monetary data; average returns; fund manager; net assets; investment objective. The document processor may be further programmed to generate a user-readable securities file from the computer-readable securities file. The document processor may be further programmed to send the user-readable mutual fund prospectus to a user. In another embodiment the document processor may be further programmed to generate a graphical display from the computer-readable securities file. The document processor may be further programmed to send the graphical display to a user and/or to send the graphical display to the user by sending the user a hyperlink which points to the graphical display. In one embodiment the database is a database operated under the rules of the United States Securities and Exchange Commission, or the United States Internal Revenue Service; in a further embodiment the database is EDGAR. The document processor may be further programmed to send the set of data attributes to a user. The document processor may be further programmed to generate an attribute file comprising one or more data points having an attribute within the defined set. The document processor may be further programmed to send the attribute file to a user.

Also offered is a system for preparing a computer-readable securities file, the system comprising a document processor programmed to: recognize a set of data attributes; retrieve a document from a database; mark financial information relevant to a security from the retrieved document; prepare a first computer-readable document comprising the marked relevant financial information; prepare a computer-readable securities file from the first computer-readable document, wherein a data point having an attribute within the defined set, and found within the computer-readable securities file, is marked as having the attribute in the computer-readable securities file.

Also offered is a system for preparing a computer-readable securities file, the system comprising a document processor programmed to: recognize a set of data attributes; retrieve a document from a database; mark information relevant to a security from the retrieved document; prepare a first computer-readable document comprising the marked relevant information; prepare a second computer-readable document from the first computer-readable document, wherein a data point having an attribute within the defined set, and found within the second computer-readable document, is marked as having the attribute in the second computer-readable document; and generate the computer-readable securities file from the second computer-readable document. In the above mentioned systems the security may be a mutual fund.

Also offered is a system for tagging a securities document, the system comprising a document processor programmed to: retrieve compliance information from EDGAR; identify particular data located in the compliance information; and insert a tag identifying the particular data into the compliance information. In this system the database may be a database operated under the rules of the United States Securities and Exchange Commission, or the United States Internal Revenue Service. In a further embodiment, the database is EDGAR. The tag may be computer-readable. Further, the second computer-readable document may be marked according to a standard generalized markup language standard. The tag may be created according to an eXtensible Markup Language standard.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a flowchart of a method according to the present invention;

FIG. 2 is a block diagram of an example of a general purpose computer according to the present invention;

FIG. 3 is a block diagram of an example of a computer and program server according to the present invention;

FIG. 4 is a block diagram of an example of an obtainment system according to the present invention;

FIG. 5 is a block diagram of an example of a client and a compliance information server according to the present invention;

FIG. 6 is a block diagram of an example of a compliance information server according to the present invention;

FIG. 7 is a flowchart of a method for responding to requests for compliance information according to an aspect of the present invention;

FIG. 8 is a flowchart of steps performed in the acquisition of securities information subsystem;

FIG. 9 is a representation of a section of securities information retrieved from the SEC EDGAR database;

FIG. 10 is a flowchart of steps performed in the cataloging subsystem;

FIG. 11 is a screen display presented by the cataloging subsystem;

FIG. 12 is a flowchart of steps performed in the splitting subsystem;

FIG. 13 is a flowchart of steps performed in the effective date determining subsystem;

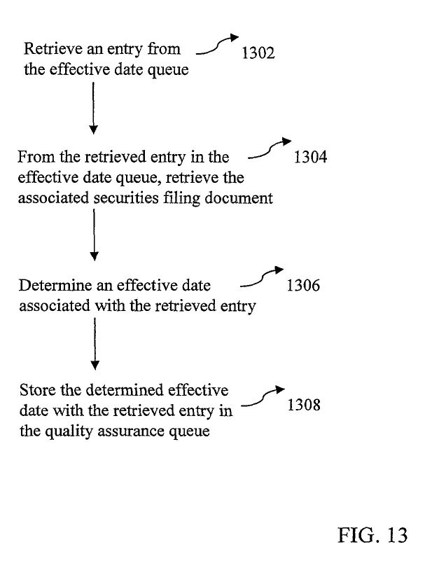

FIG. 14 is a flowchart of steps performed in the quality assurance subsystem;

FIG. 15 is a block diagram of an example of an obtainment system implementing document mark-up;

FIG. 16 is a flowchart of a method for marking up a compliance document;

FIG. 17 is an example of a Document Type Declaration (DTD);

FIG. 18 is an example of a portion of a compliance document marked up according to the DTD;

FIG. 19 is another example of a portion of a compliance document marked up according to the DTD;

FIG. 20 is a graphical representation of information that is contained in the portion represented in FIG. 19; and

FIG. 21 is a block diagram of an XML-based system to generate a mutual fund prospectus.

### DESCRIPTION

Compliance, as used herein, is a subset of securities information, more specifically certain information about a security that a government or a stock exchange requires be made available or delivered to an investor (or potential inventor) in that security. For example, the SEC and the National Association of Securities Dealers (“NASD”) each requires the filing of certain information by an issuer of securities, this is an example of securities information. The SEC and NASD require that a certain subset of the securities information be made available to an investor in a security—this is compliance information, also referred to as regulated financial information documents (“RFID”).

One example of compliance information is a mutual fund prospectus. The mutual fund prospectus could be located somewhere within an EDGAR filing that also contains other securities information, such as an amendment to a different prospectus, or a semiannual report. Compliance information for a mutual fund can include, but is not limited to, prospectuses, supplements to prospectuses (“stickers”), statements of additional information (“SAI”), supplements to SAIs, annual reports, and semi-annual reports. Certain sales and marketing information can also be considered compliance information since its distribution is also regulated by government agency and stock exchange rules. As another example, compliance information for a variable annuity fund includes the compliance information for the variable annuity fund, and the compliance information for each of the funds available for investment.

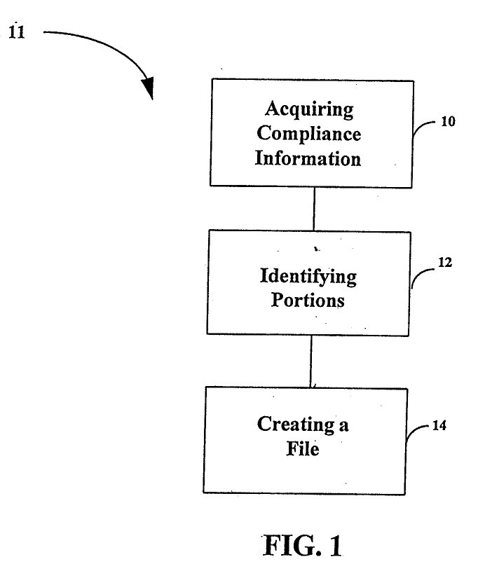

Referring to FIG. 1, a method 11 of mapping securities information comprises acquiring securities information from one or more database sources (Step 10). One or more portions of the acquired securities information is identified as related to a particular security, and extracted from the securities information (Step 12). A computer readable file is created that includes the identified and extracted portions of the securities information (Step 14). This computer readable file, identified as being related to a particular security, enables the electronic transmittal of compliance information.

As discussed above, government and stock exchange regulations, regarding the sale of securities by an issuer or intermediary to an investor, mandate the availability and delivery of compliance information. Without the compliance information in an electronic format, a seller would be required to make a physical copy of the information available to the buyer. This is expensive for the seller and adds delay to the process of purchasing securities. By extracting compliance information so that it is available in electronic format, one aspect of the present invention enables electronic securities transactions. An example of an electronic securities transaction is one where the entire process occurs over a computer network, e.g., the Internet, where no paper-based communications are sent.

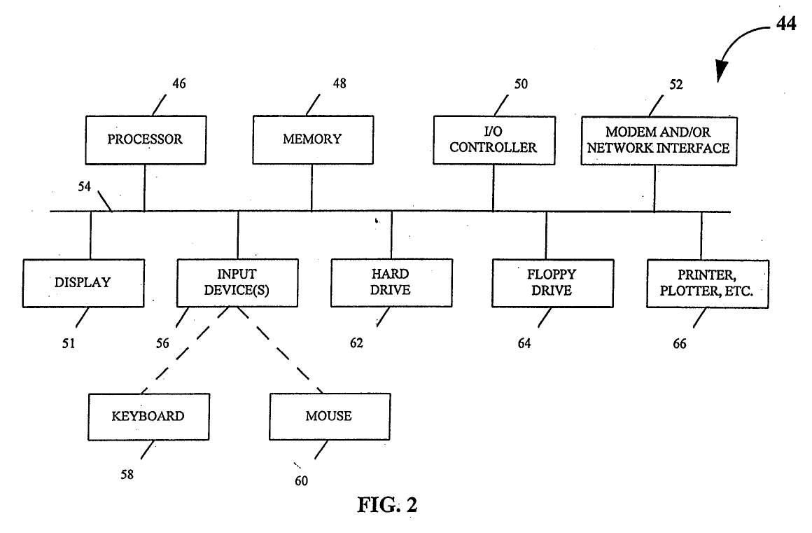

In one aspect of the invention, the method 11 shown in FIG. 1 is accomplished by one or more persons operating a programmed computer system. A block diagram of such a computer system is shown in FIG. 2. The computer may be any computer or workstation such as a PC or PC-compatible machine, an Apple Macintosh, a Sun workstation, etc. The particular type of computer or workstation is not central to the invention. The invention may be implemented in a variety of ways including an all-hardware embodiment in which dedicated electronic circuits are designed to perform all of the functionality that the programmed computer can perform. An example of the present invention is an implementation in software for execution on a general purpose computer such as a PC running a version of the Microsoft Windows operating system.

Referring to FIG. 2, the general purpose computer 44 typically includes a central processor 46, a main memory unit 48 for storing programs and/or data, an input/output (I/O) controller 50, a display device 51, and a data bus 54 coupling these components to allow communication there between. The memory 48 generally includes random access memory (RAM) and read only memory (ROM). The computer 44 typically also has one or more input devices 56 such as a keyboard 58, and a mouse 60. The computer typically also has a hard drive 62 with hard disks therein and a floppy disk drive 64 for receiving floppy disks such as 3.5 inch disks. A data communications interface 52 such as a modem, an Ethernet card, or other network interface allows communication with other computers on a LAN, intranet or Internet. Other devices also can be part of the computer 44 including output devices 66 (e.g., printer or plotter) and/or optical disk drives for receiving and reading digital data on a CD-ROM. In the present invention, one or more computer software programs define the operational capabilities of the computer 44. These software programs may be loaded onto the hard drive 62 and/or into the memory 48 of the computer via the floppy disk drive 64 or the data communications interface 52.

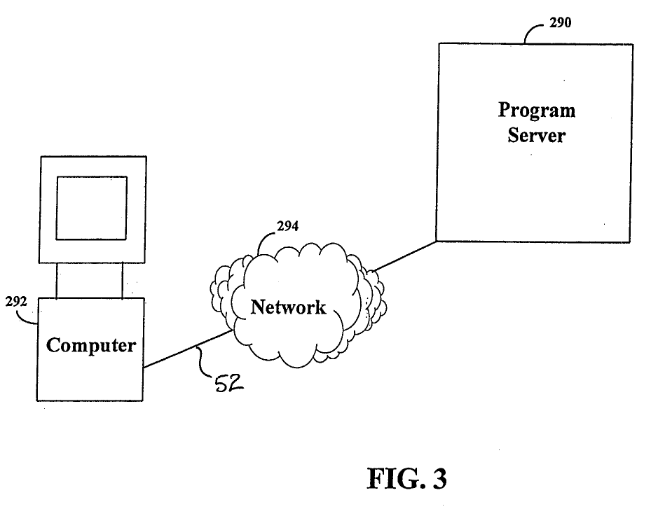

Referring to FIG. 3, one aspect of the present invention includes a computer 292 connected to a network 294 via a data communications interface 52. Computer programs that implement an embodiment of the invention are stored on a program server 290, which is another computer, that can be implemented by a general purpose computer 44. Generally, the program server 290 has high performance components, such as a high speed processor 46 and hard drive 62, and a large amount of memory 48. The programs may be stored on the server 290 in, for example, HTML and Java languages. The computer 292 runs commercially available world wide web browser software, such as Netscape Navigator or Microsoft Explorer. The browser software downloads the HTML and Java programs from the program server 290, and executes the programs. The use of a network 294 and browser software makes the programs available to a large number of computers on the network simultaneously. This facilitates operation of the system by multiple users at the same time.

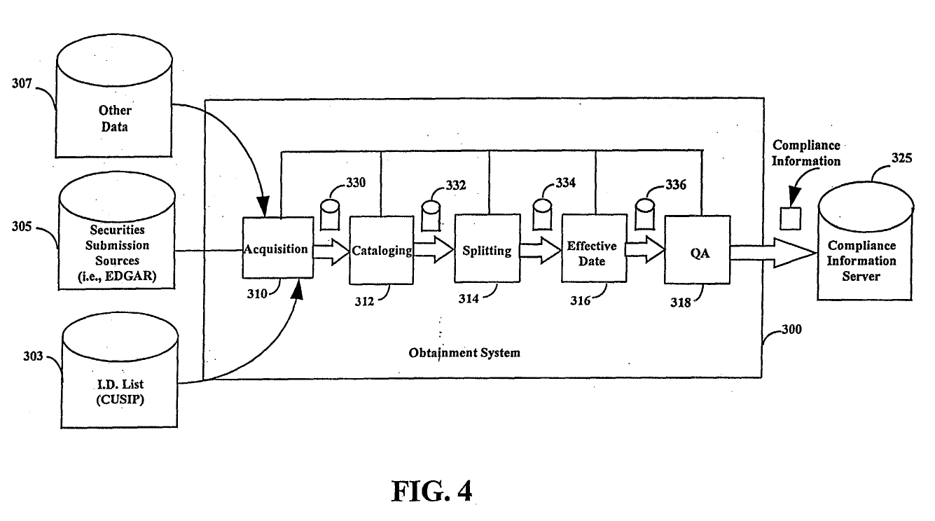

Referring to FIG. 4, one aspect of the present invention includes an obtainment system 300. Obtainment system 300 contains an acquisition subsystem 310, a cataloging subsystem 312, a splitting subsystem 314, an effective date subsystem 316, and a quality assurance subsystem 318. Obtainment system 300 receives input from an identification list 303, securities submissions sources 305, and other data sources 307. Obtainment subsystem 300 produces compliance information that may be delivered to a customer, or stored in a compliance information database 325 for subsequent delivery to a customer.

The acquisition subsystem 310 receives input from the securities submission sources 305 and other data sources 307. The securities information acquired by acquisition subsystem 310 is placed on a cataloging queue 330.

Cataloging subsystem 312 retrieves the securities information from the cataloging queue 330 and catalogs it. The cataloging subsystem 312 also receives as input, the securities information from the cataloging queue 330, as well as identification list 303, and other data 307. After cataloging, the securities information is placed on the splitting queue 332.

The splitting subsystem 314 retrieves the securities information from the splitting queue 332. After the splitting subsystem 314 determines start and end points of each item of compliance information in an item of securities information, the securities information is placed on the effective date queue 334.

The effective date subsystem 316 retrieves the securities information from the effective date queue 334, and determines an effective date for each item of compliance information in the securities information. The compliance information is then placed on the quality assurance queue 336.

The quality assurance subsystem retrieves the securities information from the quality assurance queue 336. The compliance information is reviewed in the quality assurance subsystem 318, and then output from the obtainment system 300.

Referring to FIG. 3 and FIG. 4, a system operator uses the computer 292 executing a browser program to connect to program server 290. Upon connecting to the program server 290, the system operator chooses, or is assigned, a particular subsystem. The system operator chooses or is assigned items on the respective input queue for that subsystem and operates the subsystem to process the retrieved data.

By dividing the system 300 into multiple subsystems and queued input for each subsystem, the processing of the documents is divided up into sub-tasks. Multiple system operators can be assigned to one of the sub-tasks, and can therefore process securities information simultaneously. For example, if there are four system operators, the first system operator may process a first securities information document in the cataloging subsystem, a second system operator may process a second securities information document in the cataloging subsystem, a third system operator may process a third securities information document in the splitting subsystem, and a fourth system operator may process a fourth securities information document in the QA subsystem. Using multiple system operators allows for rapid processing of securities submissions through the system.

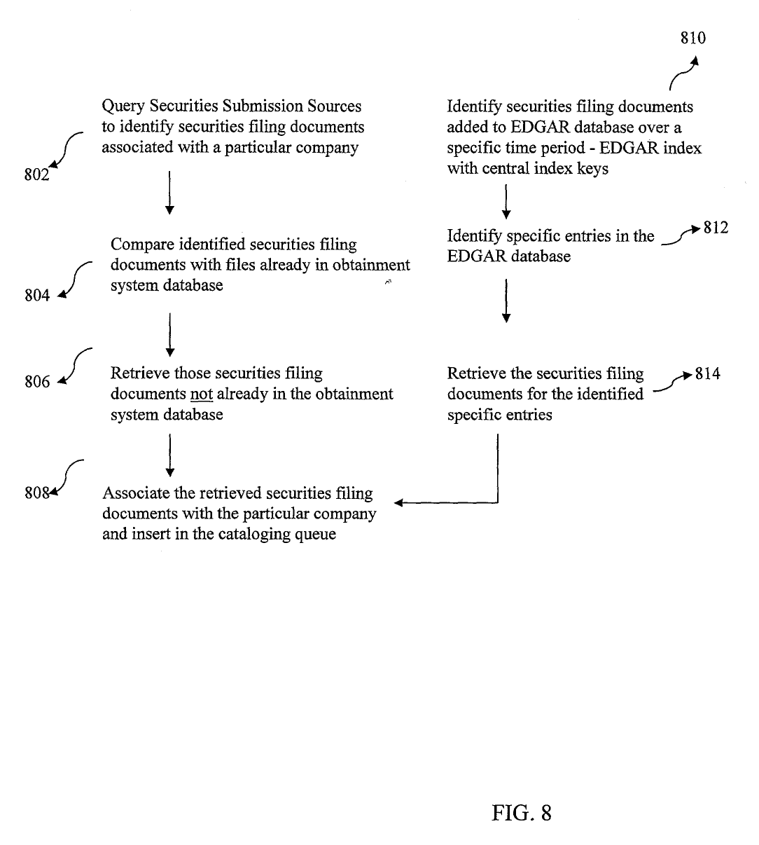

Acquisition subsystem 310 extracts files from the securities information source that contain securities information relevant to the subset of securities for which the user desires compliance information according to a process as shown in FIG. 8. In one aspect of the present invention, the securities submission source is queried to extract all the files associated with a particular company, step 802. The particular company may be determined by its central index key or by the company name. Because this may not be the first access for that particular company, the sources are compared to the information that is already in the database that is part of the system, so that the same document is not acquired twice, step 804. The subsystem thereby acquires submissions regarding securities that the user is interested in and that have not been previously processed, step 806. The acquisition subsystem, step 808, associates the retrieved securities filing documents with the particular company and then the acquisition subsystem passes the submissions to the cataloging subsystem 312.

As part of its service, EDGAR provides an index to the securities information added each day. In one aspect of the present invention, the acquisition subsystem 310 automatically acquires those documents that were added that day. The EDGAR index lists a central index key associated with each item of securities information. Acquisition subsystem 310 uses the EDGAR index to acquire the most recent information for a specific list of central index keys, step 810. The list of central index keys is determined from a list of securities each of which has a unique identifier. For example, a list of securities identified by CUSIP number or stock ticker symbol may be mapped into a list of central index keys. Specific entries in the EDGAR index are identified, step 812, and then retrieved, step 814. The process then proceeds to step 808 as described above.

The cataloging subsystem 312 presents the system operator with the securities submissions that are relevant. The system operator inspects each submission and catalogs it according to the information contained within. Each submission may contain several items of compliance information. The system operator identifies the particular securities about which the submission contains compliance information.

Another aspect of the present invention scans the submission taken from the cataloging queue and searches for and identifies possible references to securities within the submission. The operator would then be directed to the locations of these identified securities within the submission in order to verify.

Any one or more of an internal identification number, CUSIP identifiers and stock ticker symbol may be used to identify a particular security. The internal identification number is unique for each security. A CUSIP number is a number assigned by Standard & Poor's CUSIP Service Bureau, the manager of the American Banking Association's CUSIP number system, to identify a security. A stock ticker symbol is a symbol assigned by a stock exchange to identify a security. An investor is most likely to reference a security, such as a mutual fund, by any one of: the fund name marketed to the consumer, the CUSIP number, or the stock ticker symbol, and not by the investment company name or the central index key.

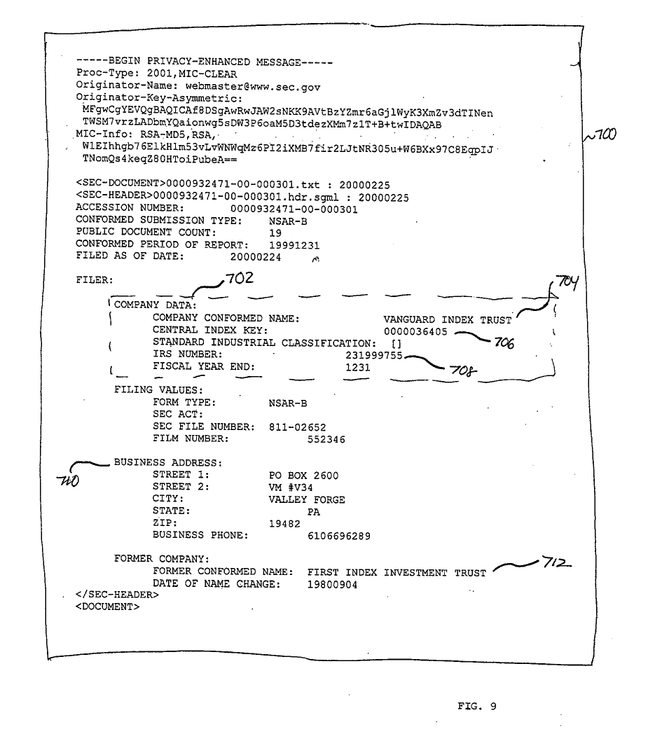

For example, a section 700 of securities information acquired from the SEC EDGAR database is shown in FIG. 9. The section 700 may include a company data portion 702 including a company name 704, a central index key 706, an IRS number 708, an address 710, and, if applicable, former company name(s) 712. The company data indicates the source of the submission (not shown), but does not necessarily specify the securities described in the submission. A particular investment management fund may have one to hundreds of funds, and information about all or some subset of those funds may be in one or more particular EDGAR submission.

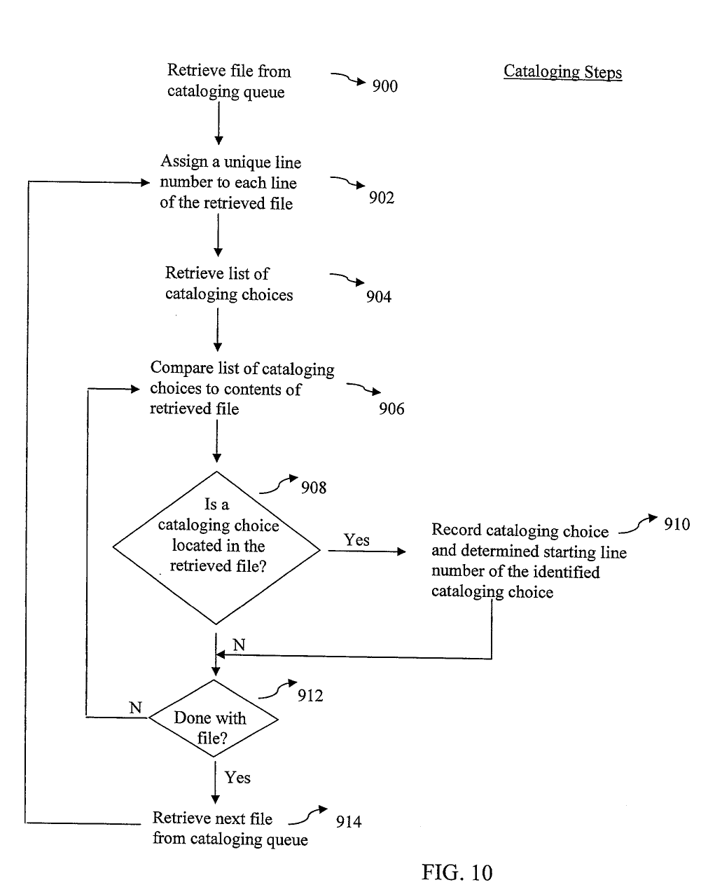

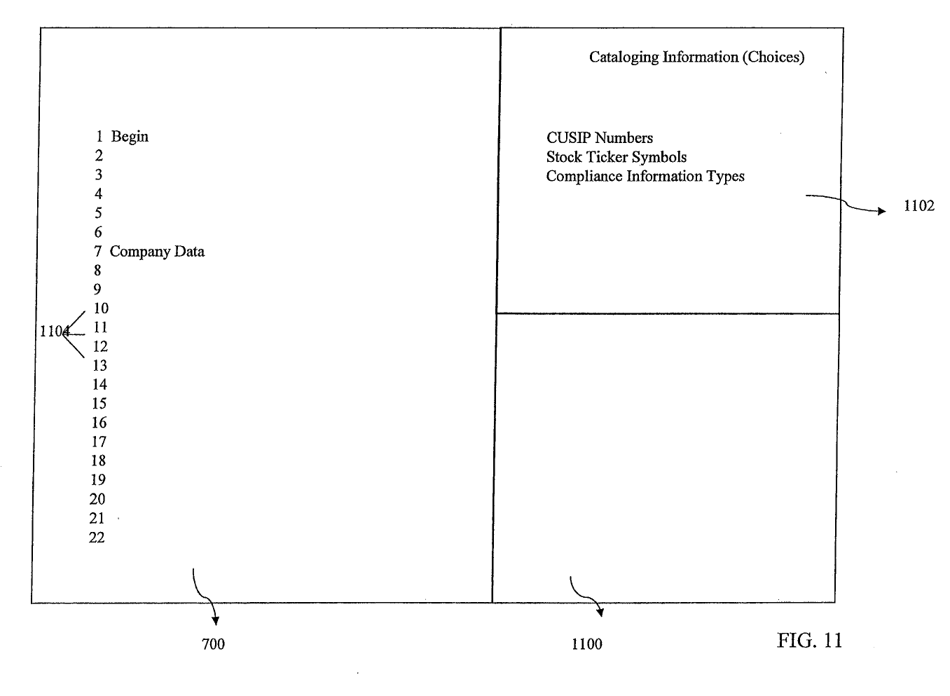

Operation of one example of a cataloging subsystem 312 is presented in FIG. 10. A securities submission from the cataloguing queue 330 is presented to a system operator and retrieved at step 900. In one example of operation, as shown in FIG. 11, the securities submission portion 700 may be visible in one section of a display screen 1100 and cataloging information 1102 may be visible on another section. A unique line number 1104 is assigned to each line of the securities submission 700 at step 902. The securities submission is not permanently modified to include the line numbers, rather, the line numbers are shown only for the purpose of aiding in the cataloging and extracting of the compliance information.

The cataloging section 1102 of the screen 1100 presents a list of cataloging choices as retrieved in step 904. Cataloging choices include possible CUSIP numbers or stock ticker symbols, the type of compliance information contained in the document (for example prospectus, SAI, etc.), and the start line of each item of compliance information. As the system operator reviews the securities submission, the system operator selects the appropriate cataloging choices.

The operator, aided by the cataloging subsystem, compares the list of cataloging choices to the contents of the retrieved file, step 906. If a cataloging choice is located in the retrieved file, step 908, control passes to step 910. At step 910, the line number associated with the start of the identified cataloging choice is recorded. If the processing of the file is not complete, as determined in step 912, the process returns to step 906. If the file has completed processing, at step 914, a next file is retrieved from the cataloging queue and the process returns to step 902.

The splitting subsystem 314 determines the starting line and ending line of the compliance information that the system will use to extract compliance information from the securities submissions documents. For example, if the submission contains two SAIs, each for a different security, the starting and ending lines of the two items of compliance information will be associated with their respective security. The splitting subsystem presents the system operator with the securities submission and the catalog data for that submission. The system operator verifies the starting line and specifies the ending line of each item of compliance information. When the starting and ending line numbers of compliance information in the securities submission have been identified, the securities submission is then placed on the effective date queue.

In one embodiment, the splitting subsystem 314 is accessed at least two times for each securities submission by two different system operators. The starting and ending line numbers identified by the two system operators are compared in the quality assurance subsystem to confirm accuracy.

In one example of the system, the splitting subsystem 314 also determines whether the compliance information relates to, or is associated with, more than one security. For example, for a bundled product such as a variable annuity fund, an EDGAR filing may be related to more than one investment product. One item of compliance information may be applicable to many different investment products. This association, as determined in the splitting subsystem, is used later to associate the compliance information with the relevant securities. Alternatively, in other versions of the system, this association may occur in the cataloging subsystem 312, or the effective date subsystem 316.

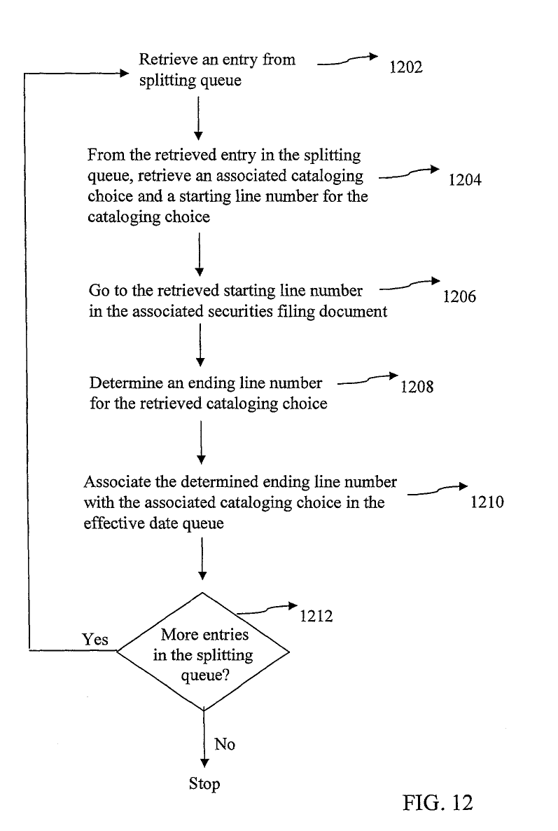

Operation of one example of the splitting subsystem 314 is presented in FIG. 12. An entry from the splitting queue is retrieved at step 1202. An associated cataloging choice and a starting line number for the cataloging choice are retrieved from the entry in the splitting queue, step 1204. That portion of the associated securities filing document including the retrieved line number is accessed, step 1206. An ending line number for the retrieved cataloging choice is determined at step 1208. The determined ending line number is associated with the associated cataloging choice in the effective date queue at step 1210. At step 1212, it is determined whether or not there are more entries in the splitting queue to be processed. If there are more entries to be processed, control returns to step 1202 to process the next entry, otherwise the process is stopped.

The effective date subsystem 316 supports a determination of an effective date of the documents produced by the cataloging process. The system operator retrieves a file from the effective date queue, steps 1302, 1304, and determines the respective effective date of the information therein. If the system operator cannot determine the effective date, but the compliance information has been determined to be a prospectus, and the system operator can determine the filing type, filing date and the prospectus date, then the system operator can determine the effective date, step 1306, through knowledge of applicable filing requirements and features built into the system, such as an automatic obsolescence feature that relates to the age of the document. After the effective date has been determined, the securities submission and its associated effective date are associated and placed on the quality assurance queue, step 1308.

The effective date is determined based on the type of securities submission. For example, if the securities submission contains a 497 or 485BPOS filing, for example, then the prospectus date is generally the effective date. If the document is a 485APOS filing, then the filing date is the “Filed As Of Date.” The effective date is generally either the prospectus date or the filing date plus sixty days, whichever is later. If the prospectus registers a new series of stock, however, then the effective date is either the prospectus date or the filing date plus seventy-five days, whichever is later. If the prospectus date is incomplete, for example “Jan. ______, 1997,” the operator can use his or her knowledge of applicable filing requirements to determine the effective date. For 497 and 485BPOS filings, for example, the filing date is the effective date, and for 485APOS, the effective date is sixty days after the filing date, unless it is registering new shares, in which case the effective date is seventy-five days after the filing date.

In one version of the system, the effective date subsystem 316 also determines if the compliance information is amending another item of compliance information. If it is an amendment, the compliance information is effective when the compliance information it is amending is effective. The effective date system sets the effective lifespan, i.e., a date the compliance information is effective and a date that it is no longer effective, to that of the amended compliance information. There are other relationships between submission types and effective dates that may be used to determine the effective date of a document being used as the basis for compliance information.

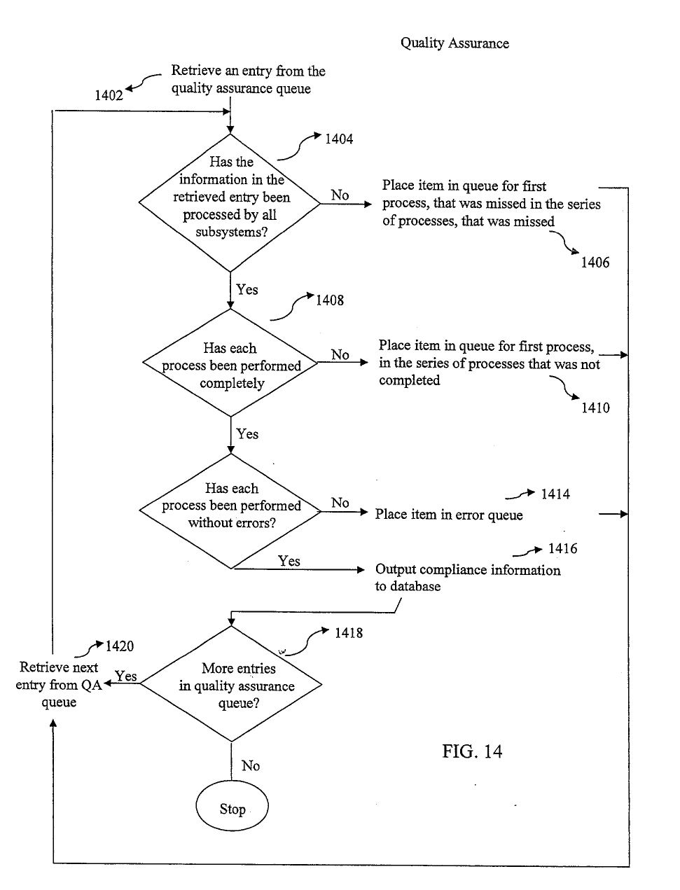

The quality assurance subsystem 318 is the final subsystem in the chain before the compliance information is output from the obtainment system. The quality assurance subsystem 318 aids an operator in the inspection of the compliance information. The system operator chooses, or is assigned, an item from the quality assurance queue, step 1402, as shown in FIG. 14. The system operator verifies, step 1404, that the securities submission referenced in the retrieved item has been processed by all subsystems. If not, at step 1406 the item is placed in the queue for the first sub-process that was missed. The system operator verifies that the catalog information is correct, and verifies the effective date, the document type, the issuer, the fund, the class, whether the document is complete, whether there is extra data, whether the document is properly formatted, as well as any other relevant information.

In the example in which the splitting subsystem 314 is accessed twice independently, the quality assurance system may compare the starting and ending lines specified by the previous two splitting subsystem 314 system operators for each item of compliance information. If any of the information for the retrieved item is not complete, step 1408, the system operator may place the securities submission on any of the queues for processing by a subsystem, step 1410. Of course, if the analysis determines that the processing should be repeated in more than one subsystem, the quality assurance system operator may choose to place the securities submission in the most “upstream” subsystem's queue. Once the system operator has verified that the compliance information will be extracted correctly, the extraction takes place and the compliance information is output from the obtainment system 300.

Extraction involves copying information from the securities submission document as a function of the starting and ending lines determined within the obtainment system 300 as described above. Of course, the same portion of the securities submission document may be retrieved as relevant to different securities. Each security would then have its own respective compliance information document.

If, as determined at step 1412, an error occurred during processing by any of the subsystems, for example if a securities submission does not contain necessary information, then the securities submission is placed on the error queue, step 1414. A system operator may look at the securities submissions that have been placed on the error queue at a later time to solve the problems encountered.

Once output from the obtainment system, the compliance information may be stored in a file system on either computer 292 or program server 290, step 1416. The compliance information may also be stored in a compliance information server 325.

At step 1418, if it is determined that there are more entries in the quality assurance queue, control passes to step 1420 where the next entry from the queue is retrieved. The process then starts again at step 1404.

In one example, the compliance information server 325 may include a document processor for converting the compliance information from its native format, for example ASCII text or HTML format, into another format, for example into Microsoft Word or Adobe Acrobat format. Of course, the compliance information, once extracted, may be kept in the source format as the original financial submission. The compliance information is then stored.

In one example of the present invention, the compliance information server 325 is incorporated into the same machine as the obtainment system 300. In this case a system for providing access to compliance information would include obtainment system 300 and an accessing system that incorporated compliance information server 325. In another embodiment the compliance information server 325 is a separate server from the obtainment system 300.

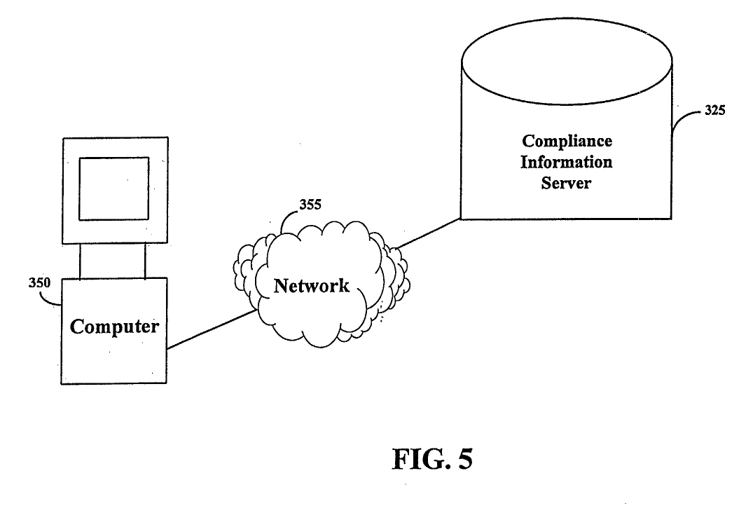

Referring to FIG. 5, a compliance information server 325 is shown connected to network 355. A client computer 350 running browser software may access the compliance information server via the network to retrieve the compliance information. The compliance information server makes the compliance information available over a network, such as a LAN, intranet or the Internet. In another example, the compliance information server 325 distributes the compliance information directly to a user or specified group of users via the network. In yet another example, the compliance information server notifies users when new compliance information has become available at the server by sending a message over the network.

The compliance information server 325 has access to the compliance information as well as the catalog information about the particular security associated with the compliance information. For example, all of the compliance information for a particular security may be listed. Because the compliance information server has the information that was entered by the system operator when the document was processed by the cataloging subsystem, all the compliance information for a particular security may be accessed either by the name of the security as it is marketed to the customer, the CUSIP number of the security, or the stock ticker symbol of the security.

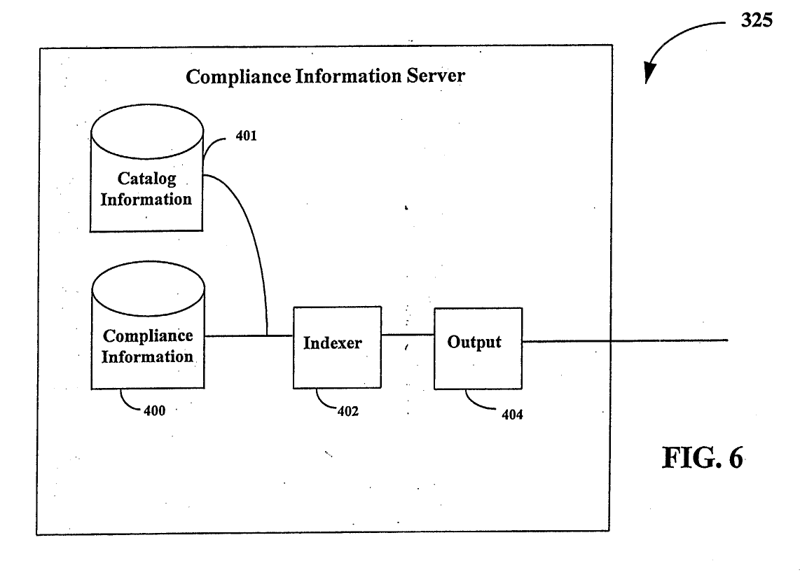

Referring to FIG. 6, one example of a compliance information server includes compliance information, an indexer, and an output. The compliance information is stored on a hard disk 400, but it also may be stored on other media, in memory, or on another system that the compliance information server has access to over the network. The compliance information includes the compliance information produced by obtainment system 300. Compliance information server 325 also includes catalog information produced by system operators using obtainment system 300. An indexer 402 accesses the compliance information and the catalog information and identifies all compliance information associated with a particular security. Alternatively, indexer 402 does not use the catalog information 401, but instead searches each item of compliance information 400 to determine the particular security with which it is associated. Indexer 402 may keep a list of the compliance information stored on hard disk 400 to increase the speed of production of a list of all compliance information associated with a particular security.

A request to compliance information server 325 may come in the form of a unique identifier for the security, such as an internal identifier, a CUSIP number or a stock ticker symbol. The indexer identifies the compliance information associated with that unique identifier. The compliance information server may output a list of the compliance information documents that are available. Alternatively, it may output the compliance information. In one example, the compliance information server receives a request for a list of all the information for a particular security. The request is in the form of a request for a web page. In response, the compliance information server 325 outputs a list of the compliance information. The list is in the form of a World Wide Web page that contains links to each of the items of compliance information. The World Wide Web page may also contain links to other information about that security.

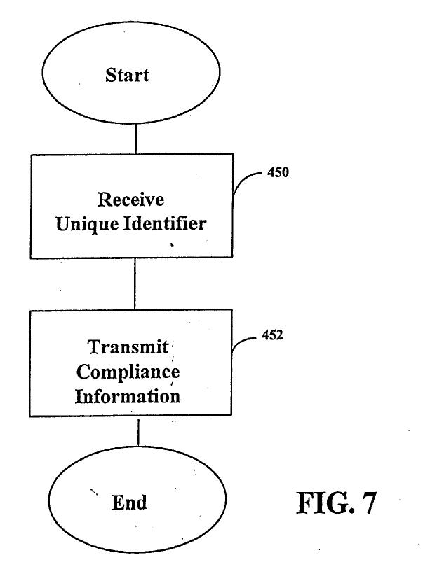

Referring to FIG. 7, a method for responding to requests for compliance information includes receiving a unique identifier (step 450). The unique identifier may be a unique internal identifier, a CUSIP number, or a stock ticker symbol. The method may also include transmitting compliance information in response to receipt of the unique identifier (step 452). The compliance information server is capable of accomplishing the steps of the method because the compliance information server has the compliance information and it can associate the compliance information with the particular security specified by the unique identifier. In one example, the compliance information is a prospectus for a mutual fund.

The foregoing describes a system wherein securities information, i.e., compliance information, available from a public filing is mapped and converted so as to extract the relevant securities information and saved in a computer-readable file. This system provides a mechanism that allows for significantly easier access to the securities information that is found within the public filings. The system distills the relevant information that otherwise would not be easily discernable from the publicly available filed documents.

The rules of the SEC, however, are specific with respect to how information is to be presented to an investor. As one example, the SEC requires a mutual fund's prospectus to provide a graph showing the annual return for past years. Usually ten years are required but less will be accepted if the fund has not been in existence that long. Usually a mutual fund prospectus presents this information in the form of a bar chart. In order for a computer-readable prospectus to comply with the SEC rules, therefore, the prospectus would have to present a bar chart showing the annual return percentages.

The present system provides a method and system for generating an SEC rules compliant mutual fund prospectus from the compliance information generated as described above, from information filed in a public database, e.g., EDGAR. The present system identifies the annual return information from within the computer-readable file that has been generated and creates a graph for presentation to the user.

The present invention takes advantage of the functions available by using Standard Generalized Markup Language (SGML) to identify the relevant data. More specifically, XML (eXtensible Markup Language) a small subset of SGML is used. SGML and XML provide a flexible and portable mechanism for representing documents. The types of components that occur in each particular type of document can be chosen and can each be labeled as they occur. For more information about SGML and XML refer to the SGML FAQ Book by Steven J. DeRose, Copyright 1997, published by Kluwer Academic Publishers, which is hereby incorporated by reference in its entirety.

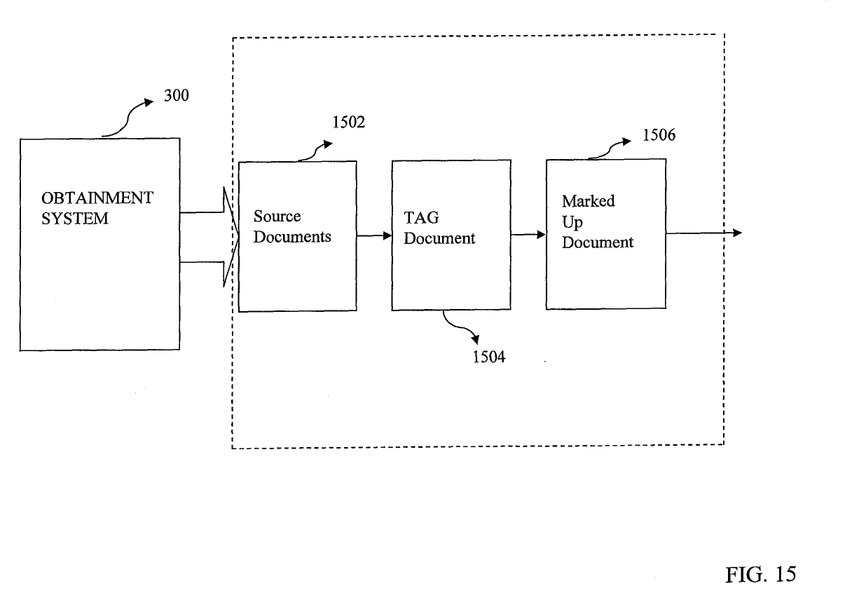

As shown in FIG. 15, output from the obtainment system 300, i.e., the compliance information as distilled from the public filing, is provided as a source document 1502 that is then tagged and converted into a tagged document 1504 (which will be explained in further detail below) resulting in a marked-up document 1506. The marked-up document 1506, because it is an XML document, is easily transported and the information identified therein is easily retrievable.

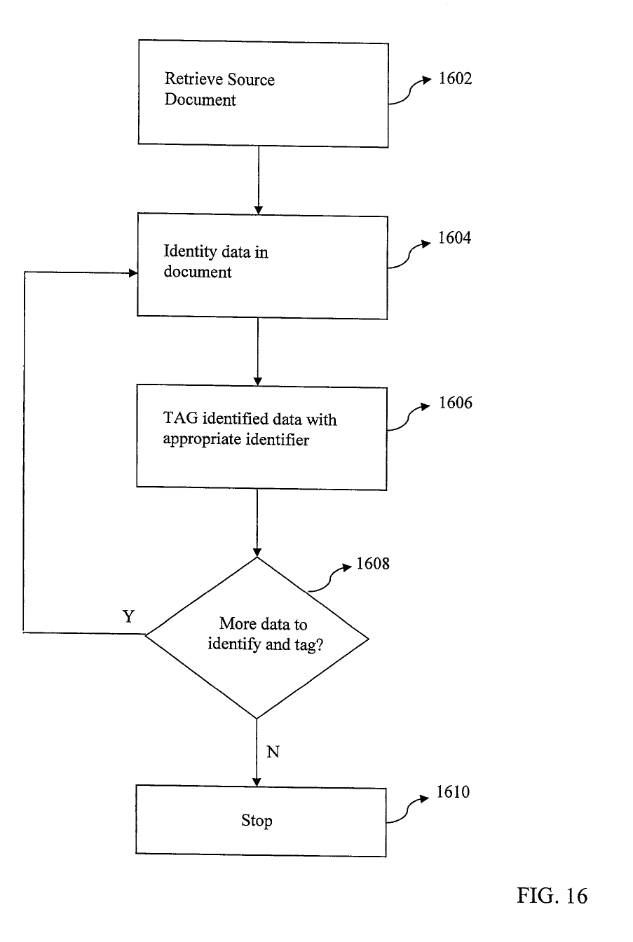

Thus, with respect to FIG. 16, at step 1602 the source document is retrieved. Data within the document is identified at step 1604 and the identified data is “tagged” with an appropriate identifier at step 1606, the details of which will be described in more detail below. If it is determined, at step 1608, that more data is to be identified and tagged, then control returns to step 1604, otherwise control moves to step 1610 where the process stops.

The specific elements contained in an XML tagged document are declared before the document begins in a Document Type Declaration (DTD). After reading a DTD, a validating parser program will check the XML tagged document for errors.

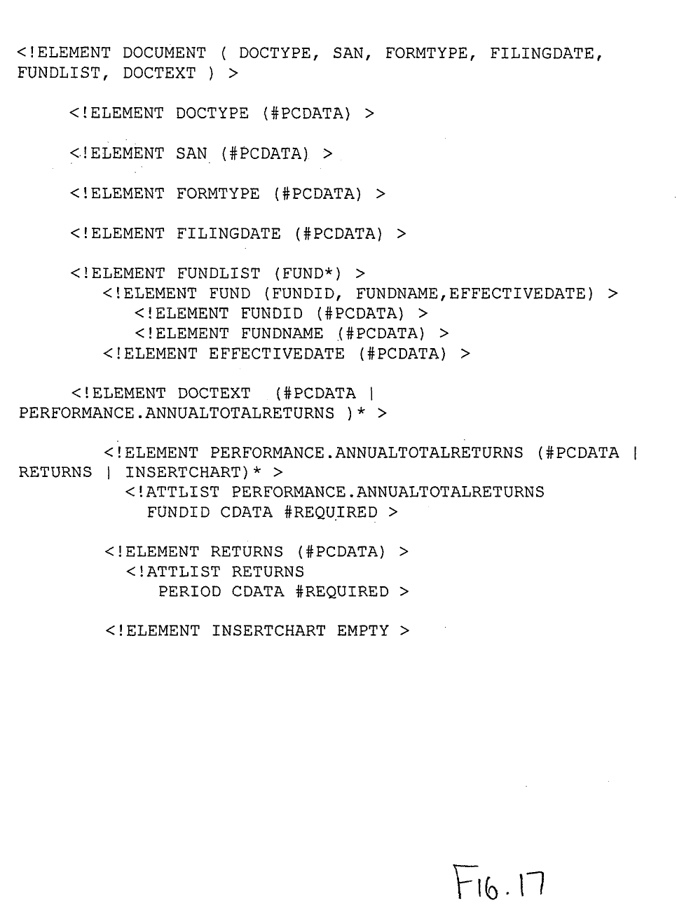

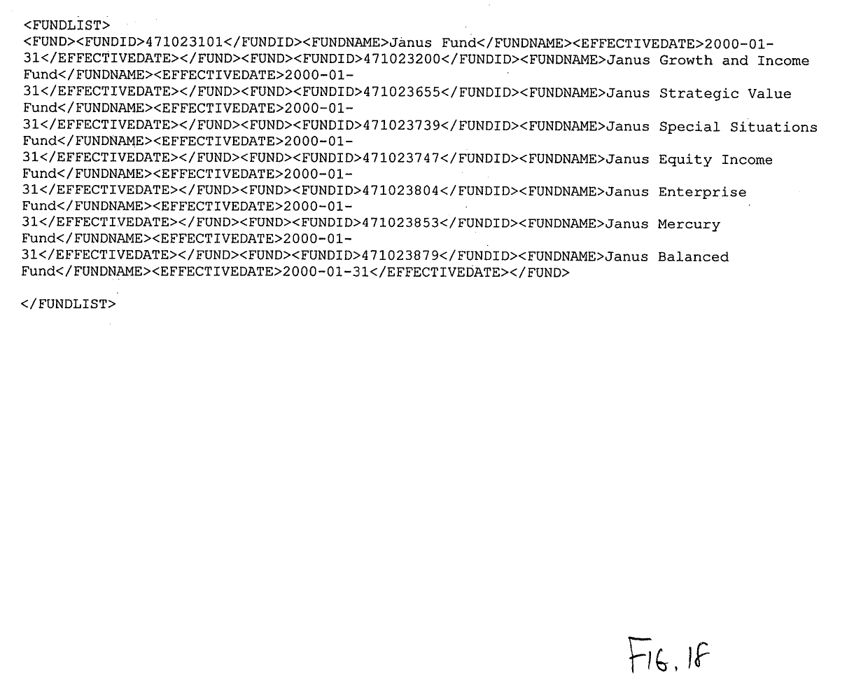

An example of a DTD, not intended to limit the present invention, is shown in FIG. 17. A number of different elements, some of which include sub-elements, are presented in this example DTD. A compliance document that has been tagged and converted into an XML document is presented in Appendix A. A portion of the document presented in Appendix A, tagged according to the element FUNDLIST in the DTD, is presented in FIG. 18.

Returning to the DTD presented in FIG. 17, one of the elements labeled “performance.annualtotalreturns” is used to generate a chart presenting the annual total returns for the fund's past ten years.

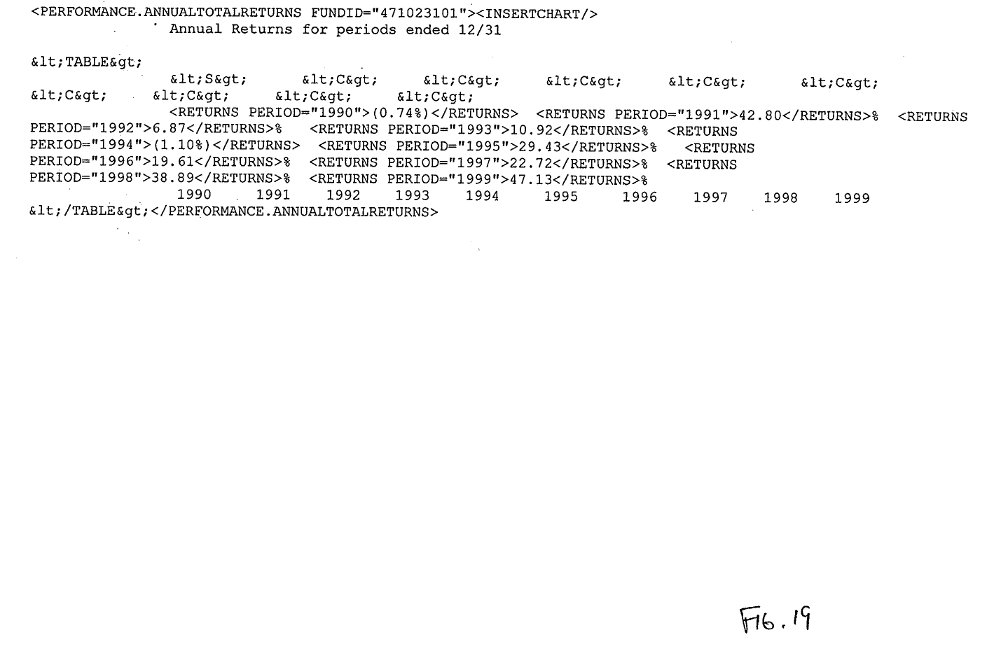

The compliance document is reviewed and tagged to identify the annual return information. As shown in FIG. 19, the annual return for the years 1990-1999 for the sample fund is presented. The information in FIG. 19 is taken from within the tagged document presented in Appendix A.

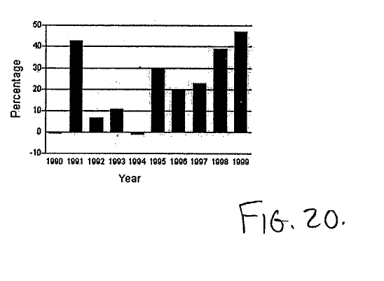

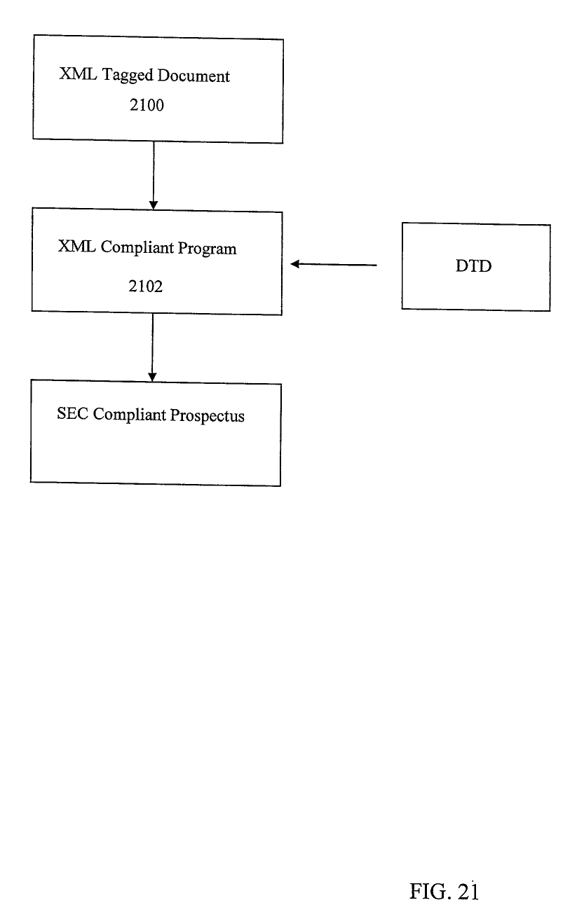

As represented in FIG. 21, after the compliance document is tagged and converted into an XML tagged document 1504, the XML tagged document 2100 is then provided to a program 2102 that recognizes the tags within the document and processes them accordingly to produce, for example, a mutual fund prospectus. With regard to the performance.annualtotalreturns element, the “returnsperiod” information is used to generate a graph as shown in FIG. 20. This graph is only a small portion of the computer-readable document that may be presented when the XML tagged document (shown in Appendix A) is processed. An example of how the XML tagged document would look, for example on a computer screen or equivalent printout, is presented in Appendix B.

The present invention also includes a mechanism for assisting an operator in tagging the compliance document. Under computer program control, the operator is assisted in finding the information that is to be “tagged” within the compliance document. The system is programmed to, for example, present to the operator a section of the document in which particular information or data points is usually found. As an example, it may be known that typically within the first fifteen lines of a prepared compliance document, specific information such as the fund's name or the fund's identification number is usually found. Thus, under control of this system, the operator would be presented with this particular section of the document in which a search by the operator could be performed to tag or otherwise extract the relevant data. In addition, the system may suggest words or phrases that the operator may use to search through the document in order to identify additional data points which are to be tagged. For example, the system may present words or phrases that are usually found in the area of the document near where the data for the annual return information is located. These search terms would allow the operator to view a portion of the document in which he/she may have a better chance of identifying the data points.

After generating the tagged document the system may create a variety of secondary documents including a user readable mutual fund prospectus, a graphical display showing selected portions of data from the tagged document, or a combination of the two. The system may also send the user an electronic copy of these new documents or may cause a written copy to be sent to the user. The system may also send the user a hyperlink pointing to any of the newly created documents or the tagged document for the user's own purposes.

Unless specifically stated herein, it should not be assumed that any described particular aspect or element of the system is essential. Further, variations, modifications, and other implementations of what is described herein will occur to those of ordinary skill in the art without departing from the spirit and the scope of the invention as claimed. In addition, in view of the foregoing description, one of ordinary skill in the art will understand that equivalent structures may be available to achieve the same results as those described above. Accordingly, the spirit and scope of the following claims should not be limited to the descriptions of the examples described herein.

What is claimed is:

1. A method of preparing a computer-readable securities file, the method comprising:
defining a set of data attributes;
retrieving a document from a database;
preparing a computer-readable securities file from the document, wherein a data point having an attribute within the defined set, and found within the computer-readable securities file, is marked as having the attribute in the computer-readable securities file.

2. The method of claim 1, wherein the computer-readable securities file is marked according to a standard generalized mark-up language standard.

3. The method of claim 1, wherein the computer-readable securities file is marked according to an extensible Markup Language standard.

4. The method of claim 1, wherein the set of attributes comprises one or more of the following:
a CUSIP number;
a stock ticker symbols;
monetary data;
average returns;
fund manager;
net assets;
investment objective.

5. The method of claim 1 further comprising generating a user-readable securities file from the computer-readable securities file.

6. The method of claim 5 further comprising sending the user-readable securities file to a user.

7. The method of claim 1 further comprising generating a graphical display from the computer-readable securities file.

8. The method of claim 7 further comprising sending the graphical display to a user.

9. The method of claim 8 wherein the sending comprises sending a user a hyperlink which points to the graphical display.

10. The method of claim 1 wherein the database is a database operated under the rules of the United States Securities and Exchange Commission, or the United States Internal Revenue Service.

11. The method of claim 10 wherein the database is EDGAR.

12. The method of claim 1 further comprising sending the set of data attributes to a user.

13. The method of claim 1 further comprising generating an attribute file comprising one or more data points having an attribute within the defined set.

14. The method of claim 13 further comprising sending the attribute file to a user.

15. A method of preparing a computer-readable securities file, the method comprising:
defining a set of data attributes;
retrieving a document from a database;
marking information relevant to a security in the retrieved document;
preparing a computer-readable document comprising the marked relevant information;
preparing a computer-readable securities file from the computer-readable document, wherein a data point having an attribute within the defined set, and found within the computer-readable securities file, is marked as having the attribute in the computer-readable securities file.

16. A method of preparing a computer-readable securities file, the method comprising:
defining a set of data attributes;
retrieving a document from the database;
marking information relevant to a security in the retrieved document;
preparing a first computer-readable document comprising the marked relevant information;
preparing a second computer-readable document from the first computer-readable document, wherein a data point having an attribute within the defined set, and found within the second computer-readable document, is marked as having the attribute in the second computer-readable document; and
generating the computer-readable securities file from the second computer-readable document.

17. The method of claim 16, wherein the second computer-readable document is marked according to a standard generalized mark-up language standard.

18. The method of claim 16, wherein the second computer-readable document is marked according to an extensible Markup Language standard.

19. The method of claim 15 or 16 wherein the security is a mutual fund.

20. A method for tagging a securities document, the method comprising:
retrieving compliance information from a database;
identifying a particular data point located in the compliance information; and
inserting a tag identifying the particular data point into the compliance information.

21. The method of claim 20 wherein the database is a database operated under the rules of the United States Securities and Exchange Commission, or the United States Internal Revenue Service.

22. The method of claim 20 wherein the database is EDGAR

23. The method of claim 20 wherein the tag is computer-readable.

24. The method of claim 20 wherein the tag is inserted according to a standard generalized mark-up language standard.

25. The method of claim 24 wherein the tag is inserted according to an eXtensible Markup Language standard.

26. A system for preparing a computer-readable securities file, the system comprising a document processor programmed to:
define a set of data attributes;
retrieve a document from a database;
prepare a computer-readable securities file from the document, wherein a data point having an attribute within the defined set, and found within the computer-readable securities file, is marked as having the attribute in the computer-readable securities file.

27. The system of claim 26, wherein the computer-readable securities file is marked according to a standard generalized mark-up language standard.

28. The system of claim 26, wherein the computer-readable securities file is marked according to an eXtensible Markup Language standard.

29. The system of claim 26, wherein the set of attributes comprises one or more of the following:
a CUSIP number;
a stock ticker symbols;
monetary data;
average returns;
fund manager;
net assets;
investment objective.

30. The system of claim 26 wherein the document processor is further programmed to generate a user-readable securities file from the computer-readable securities file.

31. The system of claim 26 wherein the document processor is further programmed to send the user-readable mutual fund prospectus to a user.

32. The system of claim 26 wherein the document processor is further programmed to generate a graphical display from the computer-readable securities file.

33. The system of claim 32 wherein the document processor is further programmed to send the graphical display to a user.

34. The system of claim 33 wherein the document processor sends the graphical display to the user by sending the user a hyperlink which points to the graphical display.

35. The system of claim 26 wherein the database is a database operated under the rules of the United States Securities and Exchange Commission, or the United States Internal Revenue Service.

36. The system of claim 35 wherein the database is EDGAR.

37. The system of claim 26 wherein the document processor is further programmed to send the set of data attributes to a user.

38. The system of claim 26 wherein the document processor is further programmed to generate an attribute file comprising one or more data points having an attribute within the defined set.

39. The system of claim 38 wherein the document processor is further programmed to send the attribute file to a user.

40. A system for preparing a computer-readable securities file, the system comprising a document processor programmed to:
recognize a set of data attributes;
retrieve a document from a database;
mark financial information relevant to a security from the retrieved document;
prepare a first computer-readable document comprising the marked relevant financial information;
prepare a computer-readable securities file from the first computer-readable document, wherein a data point having an attribute within the defined set, and found within the computer-readable securities file, is marked as having the attribute in the computer-readable securities file.

41. A system for preparing a computer-readable securities file, the system comprising a document processor programmed to:
recognize a set of data attributes;
retrieve a document from a database;
mark information relevant to a security from the retrieved document;
prepare a first computer-readable document comprising the marked relevant information;
prepare a second computer-readable document from the first computer-readable document, wherein a data point having an attribute within the defined set, and found within the second computer-readable document, is marked as having the attribute in the second computer-readable document; and
generate the computer-readable securities file from the second computer-readable document.

42. The system of claim 40 or 41 wherein the security is a mutual fund.

43. A system for tagging a securities document, the system comprising a document processor programmed to:
retrieve compliance information from EDGAR;
identify particular data located in the compliance information; and
insert a tag identifying the particular data into the compliance information.

44. The system of claim 43 wherein the database is a database operated under the rules of the United States Securities and Exchange Commission, or the United States Internal Revenue Service.

45. The system of claim 43 wherein the database is EDGAR.

46. The system of claim 43 wherein the tag is computer-readable.

47. The system of claim 43 wherein the second computer-readable document is marked according to a standard generalized mark-up language standard.

48. The system of claim 43 wherein the tag is created according to an eXtensible Markup Language standard.
